(19) United States
(12) Patent Application Publication
(10) Pub. No.: US 2015/0348427 A1
(43) Pub. Date: Dec. 3, 2015

(54) Exploiting Smart Vision Devices to Train Sports Team Tactics

(71) Applicant: David Peregrim, Westfield, NJ (US)

(72) Inventor: David Peregrim, Westfield, NJ (US)

(21) Appl. No.: 14/294,178

(22) Filed: Jun. 3, 2014

(51) Int. Cl. G09B 5/02

(52) U.S. Cl. CPC G09B 5/02

(57) ABSTRACT

This invention is used to train cohesive team tactics by delivering on-field player personalized instructions. Smart vision glasses worn by the players explain where the player is on the field thereby allowing the invention to project the next movement necessary to carry out team inclined tactical plans. The application server absorbs real-time location of players and a simulated ball, automatically compares the locations to the tactical plan, calculates the next best position of each player, and updates the smart vision glasses digital screen with the next set of optimized graphical instructions. Typically, a coach constantly stops play to address and steer one player at a time. Microchip, mobile and advanced computing technologies permit this invention to advance sports training from rudimentary, isolated means to sophisticated, connected levels.

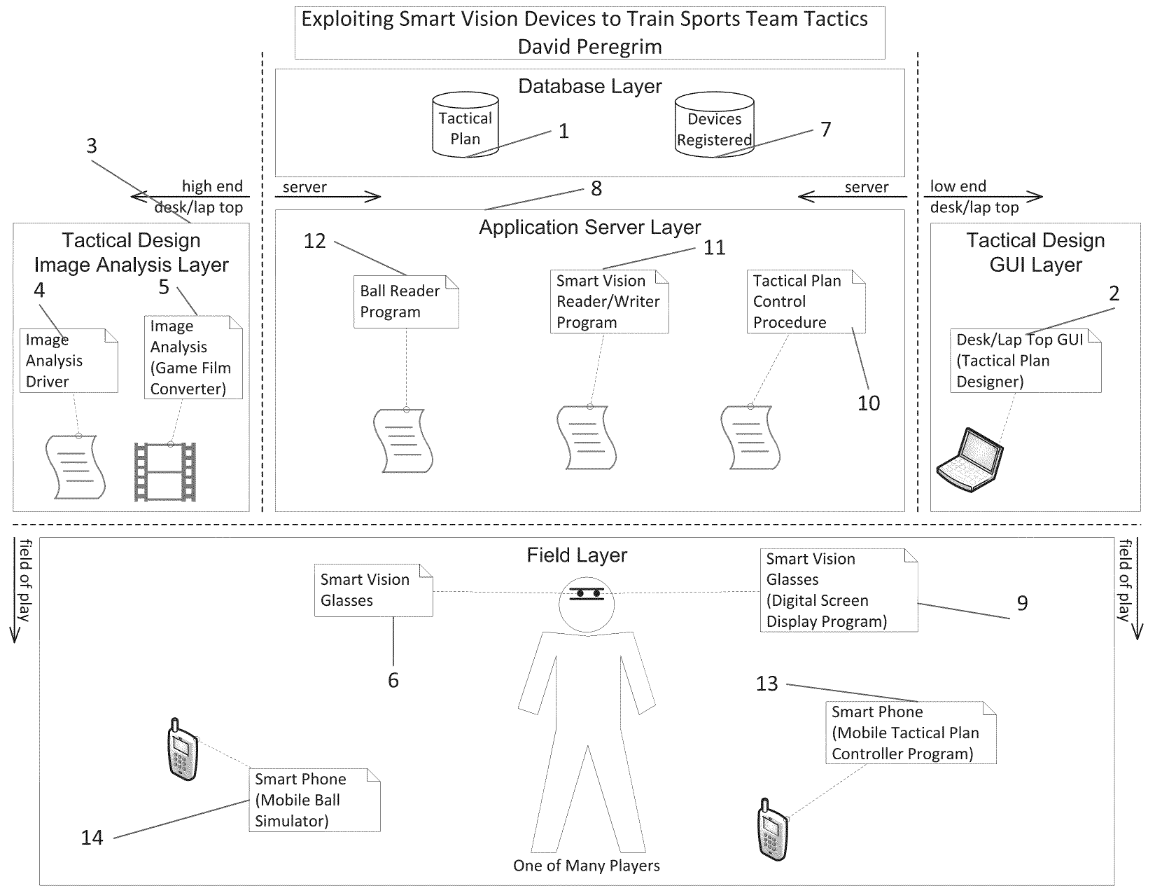

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BRIEF DESCRIPTION OF THE DRAWING

The drawing is a perspective of the software and hardware architecture needed to configure the invention.

### REFERENCE NUMERALS IN THE DRAWINGS

1 Tactical Plan Database

2 Tactical Plan Designer GUI

3 Image Analysis Software

4 Image Analysis Software Driver Program

5 Game Film Converter Program

6 Smart Vision Glasses

7 Devices Registered Database

8 Application Server

9 Digital Screen Display Program

10 Tactical Plan Control Procedure

11 Smart Vision Reader/Writer Program

12 Ball Reader Program

13 Mobile Tactical Plan Control Program

14 Mobile Ball Simulator

### BRIEF SUMMARY OF THE INVENTION

This invention engineers several different software and hardware components into an on-field, actionable sports training environment. Real-time field locations are transmitted to the application server from players' smart vision devices and a ball simulator to establish up to date positioning. The server compares desired field tactics to what is happening on the field of play, calculates field adjustments, and sends visual cues back to each player's smart vision device. The cues are etched onto the device's digital screen, which provides a panoramic view of real-time playing conditions, and instantly directs each player to their next location.

### BACKGROUND OF THE INVENTION

Sports coaches have endured centuries of inadequate and limited means to instruct and enforce on-field tactics. At best, shouted orders can only be delivered to individual players one at a time, leaving up to 10 other teammates to struggle on their own with absolutely no cohesive message from coaches. It is currently impossible to instantly and jointly address a complete field of players in an organized fashion to implement a carefully designed tactical plan. Why are team tactics so critical as compared to the individual heroics of the player with the ball? Studies of soccer matches report the average player touches the ball less than 1% of the game (53 seconds on 47 touches). What are they supposed to be doing the other 99% of time? How do they know what to do? Off the ball game awareness and keen sight of 21 other players on a field is what separates a great team player from a shallow, individualistic one. Think of the advantage an integrated lineup that has been trained to react as a unit has over one in which a game plan quickly breaks down under pressure and un-rehearsed events. Due to the difficulty of teaching tactics to more than one person at a time, it is inevitable team play suffers and tactical training further neglected, leaving the most valuable facet of the game unattainable. A favored player will get constant attention and possibly rise to greatness, while thousands of gifted athletes are left to guess at what they need to be doing off the ball.

Through modern microchip, mobile and advanced technology, a method to advance the teaching of game strategy is now achievable. This invention is the perfect solution to communicate a common tactical plan in a step-by-step, choreographed act; then advancing to near game speed as players learn quicker and enact a united front. Each player gets individualized instructions based on a customized tactical strategy, followed up by immediate adjustments to counter defensive adjustments and ball movement. Individual pre-work, prior to formal team training, is also possible with this solution as the player can learn from portrayal of position specific subdivisions of the tactical plan.

### DETAILED DESCRIPTION OF THE INVENTION

The drawing shows the architecture of the software and hardware solution. A database server contains the detailed instructions of the tactical plan [1], which when called upon by the server application, runs each player step-by-step through the tactical plan. The tactical variations are unlimited. The tactical plan is built in two ways. At least one method is necessary to drive the invention, but both can be invoked.
1. A user interacts with a graphical user interface (GUI) [2] on a low end desktop or laptop to draw a plan and save it to the database. The user is able to drag and drop players onto a field image and move them accordingly to map tactics. Each player's movement, both offense and defense, are stored in the database. The timing is critical to the maneuvers, therefore the GUI enables the user to easily group and move players at the same time, then grab additional player(s) to respond by joining or opposing. Time and space dependencies for players on the screen are a fixture of the GUI, straightforward to manage and view.
2. Considerable efficiencies to capture game tactics are systematized by using commercially available image analysis software [3] to recognize each individual player from game film and convert the on-field movement to the same database information as option 1. Operating on a high end desktop or laptop, these imaging technologies are capable of using player number, facial elements, and body size to uniquely identify each player and follow them for specified time periods. Player coverage within the film drives the length of time a sequence of movement can be documented. The imaging system's application programming interface (API) is accessed by an image analysis software driver program [4] to operate the analysis and retrieve results. Once results are exported from the image analysis software, a game film converter program [5] transforms the image results to tactical instructions stored in the tactical plan database. The GUI is used to modify the plan re-casted from game film. This automated technique will allow world class sequences of actions and tactics to be electronically captured and delivered via the invention to on-field training sessions.

An on-body computing device (i.e., smart vision glasses) [6] is exploited to send and receive messages to/from the application server. Each device's address [7] is registered to one, and only one player, in the application server. The application server [8] monitors the changing location of all devices from the device's location positioning coordinates in order to react, correct midcourse, and reissue commands driven by the tactical plan. The smart vision glasses' digital screen, controlled by a digital screen display program [9], instantly projects the direction and distance to the next destination.

An application server operates between the database and the on-body computing device worn by the players on the field. Messages are sent back and forth from the server to the on-body computing device guiding all player movement thusly:
1. A tactical plan control procedure [10] on the server reads tactical plan instructions defined in the database and starts the movement of players by having the smart vision reader/writer program [11] send a message to the smart vision digital screens. This program also reads return messages from the smart vision glasses.
2. Device location coordinates understood by the smart vision reader/writer and ball reader [12] programs allow the server to immediately understand the changes in position of all players.
3. A server procedure compares the simulated ball and each player's new position to the plan and sends immediate message back to the on-body computing device to move the player to the desired field location.
4. The cycle is constantly repeated to dispatch spontaneous readjustment. The plan is delivered to the players at the speed in which they move on the field, from walking to running.
5. In the case of pre-work prior to formal team training, subdivisions of the tactical plan, filtered by position, can be downloaded to the smart vision device, allowing instructions to be run without necessary tethering to the application server. Real-time adjustments to counter movements of competing devices are not available in this scenario.

A program running on a smart phone [13] is used to control the tactical plan server procedure. This smart phone is registered to the application server as the “controller” device. The user, generally the coach, is able to start and stop the tactical plan at any time point in the recording. Either the same smart phone or a second phone can simulate the ball [14], passing from one player to another. Alternatively, a microchip capable of emitting latitude and longitude can be secured to the inside of a ball to make training more realistic. The address of the phone taking on the appearance of the ball, or the microchip ball itself, needs to be registered to the server as “the ball”. The microchip ball is not a protective claim of this patent filing.

Having described my invention, I claim:

1. Software and hardware architecture to store team tactical plan instructions in a database and use those instructions to direct the movement of players on an actual field of play by signaling on-body smart vision glasses worn by the players. Said architecture is comprised of:
a. Database tables for storing instructions in tactical plan and device addresses.
b. Computing program and associated GUI to design tactics and store them in the database.
c. Commercially available image analysis software.
d. A computing program to access the image analysis API and drive the image analysis software.
e. A computing program to convert the image analysis output to tactical plan instructions and store them in the database.
f. Commercially available on-body smart vision glasses.
g. A computing program on the smart vision glasses communicating with the application server.
h. A computing program on a smart phone controlling the software on the application server.
i. A computing program on the application server to absorb location output (i.e., position on field in latitude and longitude) from the smart phone application simulating a ball.
j. A computing program on the application server to send and receive commands to/from the on-body smart vision glasses.
k. A computing program on the application server to accept commands from the controlling application on the smart phone.
l. An application server.

2. Tactical plan instructions as recited in claim 1.a are defined in sufficient depth in a database to move each player on a field to a specific location at a specified time point. Additionally, the database links each smart vision device claimed in 7 to a player in the tactical plan and similarly knows the smart phone acting as the ball.

3. Computing program as recited in claim 1.b capable of delivering a GUI on a low end desktop or laptop computer to manage the design of a tactical plan that results in instructions as explained in claim 2.

4. Use of commercially available image analysis software as recited in claim 1.c.

5. Computing program as recited in claim 1.d to use the image analysis API to uniquely identify every player within a film segment, follow each image's (i.e., player) movement, and provide time stamped output (i.e., location on the field) of the movement. The image analysis software must be trained and configured on how to recognize each player in the film.

6. Computing program as recited in claim 1.e capable of interpreting the image analysis output as detailed in claim 5 and converting to tactical plan instructions as explained and stored in claim 2.

7. Commercially available smart vision glasses as recited in claim 1.f armed with a computing program noted in claim 8.

8. Computing program on smart vision glasses as recited in claim 1.g to post location changes of the smart vision glasses to the application server and receive and visually project direction and distance to the next destination on the glasses' digital screen. When used for individualized per-work enactment of the tactical plan, this program provides step-by-step coaching without necessity of the application server.

9. Computing program on the smart phone as recited in claim 1.h used to control actions being delivered to the smart vision devices by the application server. The user is able to start and stop the tactical plan at any point in time.

10. Computing program on the application server as recited in claim 1.i to absorb location output (i.e., position on field in latitude and longitude) from the smart phone application simulating a ball. Although the microchip ball is not in and of itself part of these claims, this same application is able to likewise absorb the same location output from the microchip ball.

11. Computing program on the application server as recited in claim 1.j capable of interpreting output (i.e., position on field in latitude and longitude) from the smart vision glasses, joining this known position with the current step in the tactical plan, extrapolating the next step based on the plan and the position of all other offensive and defensive players on the field, and sending next step input (i.e., graphics and text) back to the smart vision glasses' digital screen noted in claim 7.

12. Computing program on the application server as recited in claim 1.k to process instructions to start and stop the tactical plan at specific point in time and to start running the plan at a desired speed.

13. An application server as recited in claim 1.l to host the computing programs as described in claims 10, 11 and 12.
